(19) United States
(12) Patent Application Publication
(10) Pub. No.: US 2014/0278830 A1
(43) Pub. Date: Sep. 18, 2014

(54) METHOD FOR INJURY PREVENTION AND JOB-SPECIFIC REHABILITATION

(71) Applicant: U.S. Physical Therapy, Inc., Houston, TX (US)

(72) Inventor: Raoul Joseph Gagne, Houston, TX (US)

(73) Assignee: U.S. Physical Therapy, Inc., Houston, TX (US)

(21) Appl. No.: 13/954,818

(22) Filed: Jul. 30, 2013

Related U.S. Application Data
(60) Provisional application No. 61/789,276, filed on Mar. 15, 2013.

(51) Int. Cl. G06Q 10/06

(52) U.S. Cl. CPC G06Q 10/06398
USPC 705/7.42

(57) ABSTRACT

Embodiments of the present invention generally relate to methods of preventing injury to a person related to job demand. Embodiments generally include comparative monitoring of the current status of the person as related to one or more job demands. The current status is compared to both previous status and desired status to help prevent injury and speed recovery post-injury.

### CROSS-REFERENCE TO RELATED APPLICATIONS

This application claims benefit of U.S. Provisional Patent Application Ser. No. 61/789,276, filed Mar. 15, 2013 (USPT/0003USL), which is incorporated herein by reference.

### BACKGROUND OF THE INVENTION

1. Field of the Invention

Embodiments disclosed herein generally relate to prevention of injury. More specifically, embodiments generally relate to methods of conditioning and monitoring of an employee to prevent and treat job-related injury.

2. Description of the Related Art

Nearly three million nonfatal workplace injuries and illnesses were reported by private industry employers in 2011, resulting in an incidence rate of 3.5 cases per 100 equivalent full-time workers, according to the U.S. Bureau of Labor Statistics. Workplace injuries can be categorized into two major categories: impact injuries and overexertion injuries. Impact injuries are often the result of a safety infraction of some kind, either by the worker or by the employer. Overexertion injuries, which include repetitive stress injuries and musculoskeletal disorders, are typically caused by work tasks that require frequent repeated movements or stresses. The types of injuries are common in manufacturing and assembly line operations.

Impact injuries can be generally addressed more directly, such as implementing safety protocols, increased training prior to operating heavy equipment or updating machines based on new innovations. However, overexertion injuries are more difficult to address, as they occur even in the most attentive employee and in the safest environments, based on the expected performance of a repetitive task. Over 41 percent of all injuries are overexertion injuries, e.g. musculoskeletal disorders. Further, although overexertion injuries may appear much less dramatic than certain impact injuries, such as macro trauma injuries, they often present more complex and expensive challenges.

There are a wide variety of responses which can be taken to help prevent overexertion injuries, such as specialized equipment to reduce the effects of the task on the body (such as a lumbar supporting back brace or ergonomic chairs). However, these attempts have met with limited success. Even considering the use of ergonomic devices, there are almost 1700 non-fatal on-the-job injuries in the United States every day, excluding illness. Annually, this adds up to 427,000 non-fatal injuries with a direct economic cost estimated at approximately $12 billion and an indirect economic cost of $47 billion. A significant portion of these costs are borne by employers, who pay in the form of lost profits, increased insurance premium costs and worker's compensation claims.

As such, there is a need in the art for better methods of preventing and avoiding job related injuries.

### SUMMARY OF THE INVENTION

Embodiments disclosed herein generally relate to methods of job-based injury prevention and conditioning for job demands. In one embodiment, a method of monitoring and conditioning a person can include performing an analysis of a job to determine one or more job demands; determining an expected state of a person based on the one or more job demands; performing a screen to determine a baseline state of the person; comparing the baseline state of the person to the expected state, the comparison comprising one or more developmental goals; providing an development regimen to the person, wherein the development regimen targets the one or more developmental goals for achieving the expected state; performing one or more functional requirement evaluations during and after performance of the development regimen to assess progress with relation to the one or more developmental goals; adjusting the development regimen in response to the one or more second functional requirement evaluations until the expected state is reached; tasking the person to perform the one or more job demands which corresponds with the expected state; monitoring the person during performance of the one or more job demands for an injury event or a pre-injury event; and if an injury event or pre-injury event occurs, providing a job-specific rehabilitation to achieve a rehabilitated state, wherein the job-specific rehabilitation is function oriented.

In another embodiment, a method for providing job-specific rehabilitation can include performing an analysis of a job to determine one or more job demands; determining a rehabilitated performance of the person based on the one or more job demands; performing a screen to assess a beginning performance of a person; providing a rehabilitation regimen to the person which accommodates for the difference between the beginning performance or a current performance and the rehabilitated performance as associated with the one or more job demands, wherein the rehabilitation regimen comprises modified work, transitional work, job rotation, physical therapy, fitness programs or combinations thereof; performing a functional requirement evaluation to assess the current performance of the person after receiving the rehabilitation regimen over a period of time, wherein the rehabilitation regimen helps the person achieve the rehabilitated performance; updating the rehabilitation regimen to accommodate the difference between the current performance and the rehabilitated performance; and repeating providing the rehabilitation regimen, performing the functional requirement evaluation and updating the rehabilitation regimen until the person has at least achieved the rehabilitated performance.

In another embodiment, a method of preventing injury in a person can include performing an analysis of a job to determine one or more job demands; performing one or more screens to assess a healthy performance of a person over a period of time, wherein the healthy performance corresponds to the ability of the person to fulfill a job demand after reaching at least an expected performance but prior to injury; periodically performing a functional requirement evaluation to assess a current performance of the person; comparing the current performance to the healthy performance to determine a change in performance related to one or more job demands; comparing change in performance to one or more known indicators of pre-injury to determine if a pre-injury state exists; if a pre-injury state exists, providing a rehabilitation regimen to the person, wherein the rehabilitation regimen comprises modified work, transitional work, job rotation, physical therapy, fitness programs or combinations thereof; and repeating periodically evaluating the current performance, comparing the current performance to the healthy performance and providing the rehabilitative regimen until the person achieves at least an expected performance.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A and 1B are a flow diagram of a method for monitoring and conditioning a person according to one embodiment;

FIGS. 2A and 2B are a flow diagram of a method for providing job-based rehabilitation according to one embodiment;

FIGS. 3A and 3B are a flow diagram of a method of preventing injury in a person according to one embodiment;

FIG. 4 is block diagram of a system configured to implement one or more aspects of embodiments of the invention; and

FIG. 5 depicts an input screen for a program configured to perform one or more embodiments described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present invention generally relate to monitoring the condition and wellbeing of a person as related to job demand. A person performing one or more job demands faces a constant risk of job-related degradation. The degradation can be from a variety of origins, such as injury (e.g. impact or overexertion injury) or age. By constantly or periodically monitoring the person in relation to job-related metrics (e.g. job performance, injury status, state of being, etc) and intervening when appropriate, job-related degradation in a person can be reduced.

Embodiments disclosed herein provide methods and apparatus to assist in determining what is required at every stage of an activity, such as employment, and to proactively either adjust the capacities of the employee, to modify the activity or both. Embodiments described herein incorporate a continuum approach to care and prevention including determine the job demands of a job, performing an assessment of a person based on the job demands, determining both injury and likelihood of injury based on the job demands, educating the employee such that the employee can avoid harm or risk of harm performing a functional requirement analysis to determine rehabilitation, preparation and harm prevention for an aging workforce and ergonomic assessment among others. Thus, through continuous monitoring of employee capacity, reevaluation of job demands, strength and conditioning of the employee in a job specific fashion and education, both impact and overexertion injuries can be minimized or avoided. Embodiments disclosed herein can be more clearly understood with reference to the figures described below which illustrate embodiments of the invention.

### “Hiring to Retiring” Continuum of Care

FIGS. 1A and 1B are a flow diagram of a method 100 for monitoring and conditioning a person according to one embodiment. The method 100 begins with performing an analysis of a job to determine one or more job demands, as in step 102. The initial determination can begin with an analysis of the job to determine the job demands. A job demands analysis is an analysis of various parameters related to the job to determine activities required by the job, physical attributes required to perform the job and known dangers in performance of the job. The job demands analysis can include a review of the work area of the person and heights where activity is required including low, medium, high and overhead. The job demands analysis can further include various material handling parameters such as lifting, lowering, pushing, pulling, carrying and twisting that are used in performing the job, including the heights of each parameter. The job demands analysis can further include physical abilities which are required for the job such as bending/stooping, climbing, crawling, kneeling, sitting, squatting, standing, walking, fingering, handling and reaching, including the heights for performing each ability. The job demands analysis can further include expected environmental conditions for performance of the job such as biological exposure, chemicals, confined spaces, dusts, electrical shock, explosives, fumes/gases/mists, humidity (including extremes and change therein), moving machinery, noise, radiant energy/burns, sharp edges, temperature (including extremes and change therein), unprotected heights, vibration, walking surfaces, wet conditions and other as may be determined relevant from time to time.

The job demands analysis can further include essential duties, critical demands and critical cadences of the job. Essential duties are the tasks that the person must do on a consistent or semi-consistent basis in performance of the job. For example, an essential duty for a secretary can be typing or word processing. Critical demands for the job are demands of the job which require a specific level of capability or physical ability for a short time. For example, an accountant can be required to make an end of the day deposit at the bank which requires lifting a 20 lb bag and delivering the 20 lb bag at the bank. Though the accountant generally requires no lifting ability for their essential duties (word processing, ten-key input, etc), the above described critical demand requires the ability to lift and carry 20 lb. Though not bound by theory, critical demands are believed to be points where an injury can occur. Critical cadence is a specific time frame where demands of the job are increased. For example, a delivery worker can generally spend their day lifting 10-50 lb boxes from a truck to a doorstep. However, at the beginning of the day, the delivery worker must load those boxes onto the truck over a short period. Though the amount lifted has not increased, the speed at which it must be done (or cadence) has increased. Though not bound by theory, critical cadences are also believed to be points where an injury can occur.

The job demands can be used to match a worker's work capability to specific job demands, for determining physician restriction of employee activity post injury and for determining rehabilitation goals among other things. The job demands can further be divided into the categories of essential and non-essential duties. Essential duties are defined as duties performed by the person which define the overall purpose of the job. Non-essential duties are duties which are not considered essential duties. Essential duties for one job can be different between jobs. Stated another way, essential duties for a first job may be either essential duties, non-essential duties or unrelated to a second job. For example, the ability to carve stone would likely be considered an essential duty to a stonemason. However, the ability to carve stone may generally be considered unrelated to the job demands of a medical doctor. Evaluation of the job also includes external factors, such as equipment used in the job and specialized training required for the equipment.

The analysis of job duties can further include a determination of risk for each of the job duties. Essential or non-essential tasks, defined generally as job demands, can vary in level of risk from high to low risk. Risk generally includes the likelihood of one or more types of injury. In determining the risk of a job demand, the risk of impact injury, overexertion injury or combinations thereof can be considered. The combination of risk and the category of the job demand can be used to determine which job demands can be modified or deleted in the case of injury. Risk can be analyzed using one or more of the four main approaches to analyzing risk, namely biomechanical, physiological, psychophysical and epidemiological approaches. The biomechanical approach uses the physical principles of the human body to determine points of stress. The physiological approach is concerned with energy consumption and stresses which act on the cardiovascular system. The psychophysical approach is an analysis of the subjective perspective of the employee based on the interaction of the biomechanical and physiological stresses of a job demand. The epidemiological approach consists of analyzing groups of people who perform a specific function to determine root causes of injuries. The above forms of risk assessment are exemplary of possible forms of risk assessment useable with one or more embodiments. Other forms of risk assessment may be used without diverging from the embodiments described herein.

Next, an expected state of a person can be determined based on the one or more job demands, as in step 104. Once the one or more job demands have been determined and classified, the expected state of the person can be determined. The expected state is a state of physical and emotional being for the person. The expected state can be defined as the state at which the person is physically capable of the desired performance of a job demand. Desired performance is generally determined by the employer. Desired performance can include minimal performance of the job demand, performance of the job demand as desired by a customer, performance of the job based on a cost benefits analysis, or performance of the job such that injuries are avoided or desired performance levels are achieved. As shown, the desired performance can be considered the limiting factor in this equation. Stated another way, the expected state is generally achievable up to at least the level of the desired performance. However, the expected state can be limited by medical necessity, such as the maximum medical improvement expected in a person.

The expected state can include various subjective and objective parameters. The subjective and objective parameters can be associated with the performance of one or more job demands or types of job demands. Types of job demands can be defined as job demands involving a similar activity or creating a similar result. Examples of types of job demands can include upper body lifting or repetitive hand gestures. Subjective parameters are parameters which are not measurable or not wholly measurable with data alone. Subjective parameters can include questionnaires of the ability of the person, self-reported activities (e.g. playing basketball or baseball), self-reported amount of activity (e.g. 30 minutes of activity a day, three days a week), dietary considerations, self-reported injuries or illnesses and the like. Objective parameters are parameters which can be determined based on data or measurement. Objective parameters can include stress tests, weight repetition tests, ability to hold a specific position, known disabilities or ailments (e.g. diabetes or handicap status), body fat percentages, observed behaviors, actual performance of the job demand and other measurable parameters. Subjective and objective parameters can be defined for achieving the expected state.

Then, a screen can be performed to determine a baseline state of a person, as in step 106. The screen is an evaluation of the physical skills and attributes which are required for the performance of the job demands, as determined by the job demands analysis. As such, the screen is job specific and specifically addresses the ability to perform the job demands.

The baseline state of the person is the state of the person without intervention by the employer or a proxy. A proxy can include doctors, colleagues or third parties. The baseline state can be determined either prior to an offer of employment being given, prior to employment beginning but after an offer of employment has been given (also known as post-offer/pre-employment) or after employment has begun. The baseline state is generally the performance of the person prior to training, education or work-based practice. The baseline state can be defined by the same parameters which define the expected state. Stated another way, the baseline state of the person can be measured with consideration of subjective and objective parameters which are informative for the job demands and define the expected state.

Determining and monitoring the baseline state generally involves a medical examination and a functional evaluation. The medical examination can include a physical exam (e.g. height, weight, palpation, etc), a medical history review, vital signs (e.g. blood pressure, pulse oximetry, temperature, echocardiogram (ECG), etc), vision testing, hearing test, and vaccination review/updating. The functional evaluation is actual performance of the one or more job functions. As the baseline state is measured with consideration of the expected state, the evaluation for the baseline state can include one or more of the above parameters, including parameters not listed above. Determining the baseline state generally relates to an initial medical examination and functional evaluation. Monitoring the baseline state generally relates to a determination of the baseline state at specific time points, specific intervals, after certain activities or events or combinations thereof. Though monitoring is listed as a specific step, monitoring can overlap with other steps and can be performed concurrently with any step of the method.

The baseline state can be determined in one or more sessions, such that the baseline state is an average of multiple measurements. A session can be generally defined as a particular measurement event (e.g. the person can have a session during which the baseline state is determined). For example, parameters X, Y, and Z are important for job demand 1. The person receives a measurement of their baseline state as defined by parameters X, Y and Z during three separate sessions thus providing three measurements. The three measurements are averaged to determine the average baseline state of the person.

Once determined, the baseline state of the person is compared to the expected state, as in step 108. Once the baseline state of the person has been determined and the expected state has been defined in relation to the one or more job demands, the baseline state and the expected state are compared. The parameters defined by the one or more job demands and associated with the expected state are compared with the equivalent parameters of the baseline state to determine which parameters are exceeded, which parameters are met and which parameters are not met. The comparison of the parameters can be either objective or subjective, though the comparison is preferentially objective.

The comparison described above is used to determine one or more developmental goals. The developmental goals can include an increased range of motion, increased balance, increased strength/endurance, improvements in posture or other improvements which can benefit one or more job demands. The developmental goals can provide guidance for a development regimen. The one or more job demands may also provide guidance for the development regimen. For example, the development regimen may be used to achieve a developmental goal, such as an increase in lifting capacity of 20%. The developmental goal is necessary for the person to reach the expected state for the one or more job demands. However, since the job demand can be focused on performing a specific function, specific muscle groups may be focused on to achieve the expected state.

Once the developmental goals are defined, the development regimen is provided to the person, as in step 110. The development regimen can target the one or more developmental goals such that the person can achieve the expected state. The development regimen can be a group of exercises designed to target one or more muscle groups for enhancing the performance of the one or more job demands. In another embodiment, other types of physical therapy or physical development are envisioned. For example, playing a sport could be used to increase stamina and balance as needed for a specific job demand. In another embodiment, a personal trainer is employed to train specific muscle groups or further physical development techniques as required to gain proficiency or to develop physical attributes.

One or more functional requirement evaluations can be performed during and after performance of the development regimen with relation to the one or more developmental goals, as in step 112. The functional requirement evaluation can be similar to the screen described above. The functional requirement evaluation can be compared with the functional capacity evaluation. The functional capacity evaluation is an evaluation of maximal output from the person on various physical skills and attributes. As such, the functional capacity evaluation is job generic and addresses the ability to work generally. By performing the functional requirement evaluation, the current state of a person is determined with relation to the job demands to assure a safe and sustained performance of the job upon returning to work.

The person can be monitored for a period of time both during the performance of the development regimen and during times that the person is not performing the development regimen. The monitoring can be done using a computing device or by an individual. The monitoring provides feedback on both the results of the exercise and other related outcomes. Related outcomes can include improvement in non-targeted parameters, possible injuries, improvement or lack thereof outside of expectations and other unknown outcomes of the development regimen. Monitoring can include subjective criteria, such as reported wellbeing and reported illness or injury, and objective criteria, such as blood pressure, metabolic profiles and strength/balance tests.

Then the development regimen is adjusted in response to the one or more second functional requirement evaluations until the person reaches the expected state, as in step 114. Using data accumulated by the one or more second functional requirement evaluations, the development regimen can be adjusted to meet the current or adjusted developmental goals of the person. One person may not benefit as much from a specific training or rehabilitation event as another person. As such, the development regimen can be adjusted to meet the needs of the person. As the person improves toward the expected state, the development regimen can be continually adjusted to accommodate any changes.

The person is then tasked to perform the one or more job demands which corresponds to the expected state, as in step 116. Once the person has achieved the expected state, the person is then ready to perform the job demand which was the subject of the expected state. It is understood that performing the job demands, as described herein, is equivalent to performing the job. Further, certain job demands may overlap both in performance, in end result or combinations thereof.

Once performance of the one or more job demands has begun, the person can be monitored both during and after performance of one or more job demands for an injury event, as in step 118. An injury event is the occurrence of any change, either external or internal to the person, which affects the person's ability to perform one or more job demands. The injury event can include physical changes, psychological changes, emotional changes or combinations thereof. The person can be monitored for injury events. Monitoring for injury events can include direct indications of change (e.g. physical trauma due to an impact injury) or indirect indications of change (e.g. a decrease in typing speed over a short period of time). The monitoring can include self-reporting of injury or objective factors which might indicate injury (such as reduction in productivity or reduction in work quality). The monitoring can also include functional capacity tests, for example a total spine range of motion test or maximal voluntary effort hand grip test. Some indications of injury can occur without conclusively showing that an injury occurred. For example, loss of productivity could mean that the employee is injured but not in all cases. If indications of an injury occur but are not definitive indications, one or more secondary tests can be performed. Examples can include simulated work task testing, distraction testing or retrial of tests.

If an injury event occurs, a job-specific rehabilitation is provided to achieve a rehabilitated state, as in step 120. Job-specific rehabilitation is defined as rehabilitation which is designed to increase performance of the person as related to the one or more job demands. The job-specific rehabilitation can be designed to progress the person toward the rehabilitated state. The rehabilitated state can correspond to the desired state of the person with consideration of the extend of the injuries, the one or more job demands and the maximum medical improvement. Job-specific rehabilitation is described more thoroughly with reference to FIG. 2 below.

After the expected state is reached, the method 100 can end at step 122. At this point, the person should be capable of performing the one or more job demands while avoiding injury and maintaining a high level of productivity. Though this method is shown in steps, this method is part of a continuum. As such, the steps may be performed in the exact order provided or the order may be altered. Further, should the capacity of the employee fall below the expected level, one or more steps may be repeated to reestablish the expected or the rehabilitated state. Thus, the method can be repeated over the course of the person's involvement with the employer or over the life of the person.

The embodiments described above create a continuum of care for the person. By determining the job demands and helping the person achieve the expected state both prior to and after injury, injury can be avoided. In the event that injury should occur, the embodiments described above can provide a safe and sustained return to work. In one or more embodiments described above, recovery time can be reduced, injury can be avoided, the possibility of disablement after injury can be mitigated and costs can be reduced for both the employer and the person.

### Job Based Rehabilitation

FIGS. 2A and 2B are a flow diagram of a method for providing job-based rehabilitation according to one embodiment. The method 200 begins at step 202 by performing an analysis of a job to determine one or more job demands. The one or more job demands can be determined by a job demands analysis, as described with reference to FIG. 1A.

Once the one or more job demands have been determined, a rehabilitated performance of a person is determined based on the one or more job demands, as in step 204. The rehabilitated performance can be determined based on the job demands and objective and subjective parameters as well as the type of injury and maximum medical improvement expected, as described with reference to the expected state of FIG. 1A. The rehabilitated performance is the performance expected of the person to perform one or more job demands. The rehabilitated performance can be defined as a desired performance level for a job demand, such as the performance of the job demand as determined by peer review, as determined by the requirements of the job, as determined by previous performance in the case of an injured current employee or based on other performance criteria.

Next, a screen can be performed to determine a baseline performance of the person, as in step 206. The baseline performance can be determined as described related to the baseline state in FIG. 1A. The baseline performance can be determined indirectly using one or more parameters, which are related to job demands. The baseline performance can also be determined directly using a job simulation which focuses on one or more specific job demands. In this embodiment, the beginning performance is a starting point for the person after an injury.

Then, a rehabilitation regimen is provided to the person which accommodates for the difference between the baseline performance or a current performance and the rehabilitated performance as associated with one or more job demands, as in step 208. The rehabilitation regimen can include modified work, transitional work, job rotation, fitness programs or combinations thereof. Modified work can involve providing engineering instruction or guidance to the employer for designing the job environment for the needs of the person. For example, modified work can include a chair or a desk to reduce strain on the lower back or to enhance certain stabilizing muscles. Transitional duties can include temporary work which can be used rehabilitatively to prepare the person for transition into the previous job. For example, an assembly line worker can be moved to a different part of the assembly line such that similar movements are used but the weight of the component is reduced. Job rotation can include performing one or more functions to use different body parts. In one embodiment, a person who performed a previous job using the entire upper torso can perform a job which uses just the back for a period of time and at a separate time perform a job which uses just the arms.

In one embodiment, a physical therapy regimen can be provided. Once it has been confirmed that an injury exists and all necessary medical protocols have been followed, a determination can be made whether the injury is physically treatable. A physically treatable injury is an injury that will respond to physical therapy. A physically treatable injury can be either currently physically treatable (such as a sprained ankle) or physically treatable after a period of recovery (such as a laceration which, after stitches and time, is treatable by physical therapy). If the injury is physically treatable, a physical therapy regimen can be created for the person. The job demands analysis can provide therapy targets for the physical therapy regimen.

The rehabilitation regimen can be designed to achieved the rehabilitated performance, which can be the expected performance, the baseline performance, a maximal performance based on injury or combinations thereof. The developmental goals may change based on the injury event, as the injury event has likely affected the person's baseline state. The expected performance may have changed based on the maximum medical improvement expected in the person after the injury event. Thus, designing the physical therapy regimen includes determining the baseline state, determining the expected state and defining the developmental goals for the person. As the person improves based on performance of the physical therapy regimen, the physical therapy regimen can be adjusted to correspond to the new developmental goals. The developmental goals may be any goal of improvement between the baseline state and the expected state. Thus, multiple developmental goals may exist between the baseline state and the expected state.

Since the rehabilitation regimen incorporates the job demands as the end result, job-specific rehabilitation is considered function oriented as opposed to disease oriented. Without intending to be bound by theory, it is believed that a function oriented rehabilitation provides a more sustained rehabilitation of the person than disease oriented rehabilitation. Disease oriented rehabilitation focuses on the disease state of the person and how to correct the disease state. The end result of disease oriented rehabilitation is the person no longer being in the disease state. Examples of disease oriented rehabilitation can include proper flexion/extension, abduction/adduction, range of motion among others. Thus, disease oriented rehabilitation is a relatively minimal criteria which does not focus on safe or sustained performance of the job. Disease oriented rehabilitation can provide for a safe return to work, as it is likely safe for the person to perform the previous job function once the disease state is gone. However, safe return is not assured from disease oriented rehabilitation. Further, disease oriented rehabilitation is not designed to provide sustainably safe return to the job. Function oriented rehabilitation focuses on being capable of performing the one or more job demands required or desired for the job. The job demands determined by the job demands analysis are incorporated into the function oriented rehabilitation such that the end result of the rehabilitation is the safe performance of one or more job functions. In this way, function oriented rehabilitation provides a safe and sustained return to work. In one or more embodiments, job-specific rehabilitation can be physical therapy, modified work, transitional duties, job rotation or further physical development techniques as required to gain proficiency or to develop physical attributes.

A functional requirement evaluation can then be performed to assess a current performance of the person after receiving the rehabilitation regimen over a period of time, as in step 210. The rehabilitation regimen is directed towards the person achieving the rehabilitated performance. The current performance of the person can be assessed after receiving the rehabilitation regimen over a period of time. The one or more rehabilitation effects of the rehabilitation regimen help the person achieve the rehabilitated performance. The functional requirement evaluation can determine, based on specific job demands based indicators, the rehabilitation achieved by the person. The rehabilitation regimen can be provided to the person for a period of time, such as a week, a month, a year or more based on the one or more job demands, the capability of the person and other factors. Both during the period of time for the rehabilitation regimen and after, performance parameters can be assessed to determine progress toward the rehabilitated performance.

Based on the functional requirement evaluation, the rehabilitation regimen can be updated to accommodate the difference between the current performance and the rehabilitated performance, as in step 212. As described with reference to FIG. 1A, the rehabilitation regimen can be updated based on improvements in performance of the person. As the current performance at specific parameters improves toward, meets or exceeds the parameters defining the rehabilitated performance, the work regimen can be modified to accommodate the improvements. Modifications can include changes in job demands, a change of job, different physical therapy routines, modified tools or other changes which provide an appropriate level of challenge to continue improvement towards the expected performance.

At step 214, the steps of providing the rehabilitation regimen, performing the functional requirement evaluation and updating the rehabilitation regimen can be repeated until the person has at least achieved the rehabilitated performance. The person may require more than one modification of the rehabilitation regimen to reach the rehabilitated performance level. The rehabilitation regimen can be again provided based on the current performance of the person, such that one or more performance goals can be achieved. The performance of the person can be reassessed and the rehabilitation regimen can be updated one or more times until the person has reached the one or more performance goals and thus achieved the rehabilitated performance.

After incurring an injury, the person may not be medically able to achieve an expected state. Though these situations are largely associated with impact injuries, overexertion injuries can reduce the maximum medical improvement of a person as well. As such, the work regimen and the expected performance may need to be modified to match the person's maximum medical improvement. Considering the magnitude and longevity of certain injuries, prevention can be preferable to treatment in some cases.

After the rehabilitated performance is reached, the method 200 can end at step 214. At this point, rehabilitation is believed to be achieved up to either the maximum medical improvement of the person or the performance needed for the job demand. Further, the method can be repeated over the course of the person's involvement with the employer or over the life of the person.

In one or more embodiments, rehabilitated performance will not correspond with expected performance. In this case, the person may be transferred to a new job which matches the rehabilitated performance. When performing a job transfer, the performance should be tested using a job transfer screen. A job transfer screen should employ the same parameters as other screens, such as a post-offer pre-employment screen.

During monitoring for job-based degradation, an injury may be discovered and may require intervention, including job-based rehabilitation. Job based rehabilitation provides a chain of events which quickly improve the overall health of the person after injury. Injury generally leads to a reduction in activity. An injury generally makes one or more activities either more difficult or painful to perform. The person subsequently performs the activity less, which creates a cycle of degradation. By creating a rehabilitation regimen which correlates the rehabilitated performance to one or more job demands, the person can be returned to the work both safely and sustainably.

### Pre-Injury Response

The prevention of injury and early discovery of injury is just as important in the continuum of care as care of injury itself. Proper discovery and response to the occurrence, described herein as a pre-injury event, can treat the portion of injury that has occurred and prevent further injury. FIGS. 3A and 3B are a flow diagram of a method of preventing injury in a person according to one embodiment. The method 300 begins at step 302 by performing an analysis of a job to determine one or more job demands. The one or more job demands can be determined by a job demands analysis, as described with reference to FIG. 1A.

Using the one or more job demands as a guide, one or more screens can be performed to assess a healthy performance of a person over a period of time, as in step 304. The healthy performance corresponds to the ability of the person to fulfill a job demand after reaching at least an expected performance but prior to injury. The healthy performance can be the same as the beginning performance, an expected performance or an intermediate performance. The healthy performance can be defined as a desired performance level for a job demand, such as the performance of the job demand as determined by peer review, as determined by the requirements of the job, as determined by previous performance in the case of an injured current employee or based on other performance criteria. The healthy performance measurement may be determined on a specific time frame, such as during an annual review. A person can generally provide a healthy performance during most of their working life and the healthy performance can be a range of performances.

A functional requirement evaluation is then performed periodically to assess a current performance of a person, as in step 308. The current performance corresponds to a current ability to perform the job demand. The current performance therefore is measured based on the parameters which define the healthy performance. The current performance can be further defined as performance measured by one or more parameters related to the job demand or functions from which the proficient performance is defined. In this embodiment, the current performance should be collected in a periodic fashion from the person, such as once a month or once a year, such that the current performance can be followed over a period of time. The current performance can be assessed by functional requirement evaluation, described above. It should be noted that the healthy performance can be a previously measured current performance that, when viewed in hindsight, shows at least adequate performance of one or more job demands for the job.

The current performance can then be compared to the healthy performance to determine a change in performance related to the one or more job demands, as in step 308 It is expected that over the course of performing a job, the person's physical capacity decreases due to one or more factors such as a physically stressful job demand, age, concomitant illnesses or other reasons. These factors are referred to as “workforce aging”. The decrease in physical capacity from workforce aging can lead to an increase in likelihood of injury, such as repetitive strain injury. Repetitive strain injury (RSI) results from a seemingly non-stressful and innocuous job demand leading to an injury based on repeated performance. More common forms of RSI include carpal tunnel syndrome for people who spend much of their time at a keyboard. Though any one performance of the job demand is not likely to create the injury, due to the repetitive nature of the job demand, an injury occurs over time. It is believed that RSIs are the result of accumulated damage over a period of time, thus the injury is immediate but the trauma leading to the injury is protracted. At some point during the protracted trauma, the person is believed to have a pre-injury condition. Pre-injury conditions are generally defined as a state of the person which directly precedes an injury. Thus, a pre-injury condition, if left untreated, can become an injury. By comparing the current performance to the healthy performance, non-reported or undiscovered pre-injury conditions may be uncovered prior to manifestation of an injury.

Without intending to be bound by theory, workforce aging is not believed to be necessarily related to age. Workforce aging relates to your time working in the environment. To mitigate the effects of workforce aging, the first step is to educate them on the possible types of injuries and how to avoid them (based on the job demands analysis and their time on the job). Secondary to education is the combination of exercises and programs which are specific to the types of injuries expected. For example, one embodiment can incorporate exercises on the job which are specific to becoming less susceptible to injury (based on the historical injury and illness data). As it is believed that you have to have a certain level of strength, conditioning and cardio to perform the job, workforce aging should be carefully monitored.

The change in performance can then be compared to one or more known indicators of pre-injury to determine if a pre-injury state exists, as in step 310. Indicators of pre-injury can be any physiological or time based indicator which reasonably correlates with a likelihood of injury. For example, pain or numbness in a specific portion of the hand or wrist may indicate a likelihood of carpal tunnel syndrome. Thus, the pain or numbness would be a known indicator of pre-injury. Known indicators can also include statistical data, such as the likelihood of injury based on time performing a specific job demand as compared to similarly-situated persons in the working community. Known indicators can change over time and current indicators may be either affirmed or denied based on later understanding.

The similarly situated person may be a category of person defined based on age and work category. Other factors that can be considered include gender, experience in the work category, specific professional differences, previous injury and the like. The comparison to the similarly situated person is used as an internal control for comparison between current performance and proficient performance. Since the similarly situated person is assumed to not have the pre-injury condition and is measured both for proficient performance and current performance, the similarly situated person's performance difference can remove false positives from the pre-injury conditions determined in the person. The comparison may include comparison to co-workers or to persons working similar jobs at other locations. Further, the similarly situated person may be a single person or an average of persons performing similar job functions, though preferably the similarly situated person comprises an average of persons performing similar job functions.

Once a pre-injury state has been determined to exist, a rehabilitative regimen can be provided to the person, as in step 312. The rehabilitative regimen can include modified work, transitional work, job rotation, physical therapy, fitness programs or combinations thereof. In one embodiment, fitness programs are employed as the rehabilitative regimen. The rehabilitative regimen can incorporate one or more elements of the rehabilitative regimens described previously. Rehabilitative regimens can incorporate ergonomic changes. Ergonomic changes comprise both ergonomic workstation analysis and ergonomic hazards analysis. Ergonomic workstation analysis incorporates analysis of the working environment to prevent injury due to interaction with the working environment, such that the workstation equipment is appropriately to determine possible injury settings. Examples can include a mat which has become frayed or a belt that is too high for the average height of the employees.

Evaluation of the current performance, comparison of the current performance to the healthy performance and provision of the rehabilitation regimen can be repeated until the person has at least achieved a rehabilitated performance, as in step 314. The rehabilitated performance can correspond to either the healthy performance or a maximal performance, as set by the maximum medical improvement. The method or steps therein may be repeated one or more times in constant review or periodic review of the performance level of the person. In this way, pre-injury conditions can be determined early and acted upon prior to the person incurring an injury for which treatment is required.

Prevention of injury requires preventative maintenance testing, which includes preventing injury and maintaining the person on the job. This portion actually monitors the individual against themselves (individual performance over time compared to current performance). Self-comparison allows an employer to catch an injury before it begins based on a percentile change in performance. This allows the employer to avoid standard rehabilitation based on a proactive response prior to injury.

### System for Monitoring and Preventing Injury

FIG. 4 is a block diagram of a system 400 configured to implement one or more aspects of the embodiments. System 400 may be a computer workstation, personal computer, personal digital assistant, or any other device suitable for practicing one or more of the embodiments described herein.

As shown, system 400 includes a central processing unit (CPU) 402 and a system memory 404 communicating via a bus path that may include a memory bridge 406. CPU 402 includes one or more processing cores, and, in operation, CPU 402 is the master processor of system 400, controlling and coordinating operations of other system components. System memory 404 stores software applications and data for use by CPU 402. CPU 402 runs software applications and optionally an operating system. Memory bridge 406, which may be, e.g., a Northbridge chip, is connected via a bus or other communication path (e.g., a HyperTransport link) to an I/O (input/output) bridge 411. I/O bridge 411, which may be, e.g., a Southbridge chip, receives user input from one or more user input devices 422 (e.g., keyboard, mouse, joystick, digitizer tablets, touch pads, touch screens, still or video cameras, motion sensors, and/or microphones) and forwards the input to CPU 402 via memory bridge 406. In one embodiment, the user input devices 422 can include hand grips, dexterity testing devices, treadmills, weights, stair climbers, accelerometers, heart monitors, pulse oximeters or other devices intended to collect information related to the one or more job functions described above.

A display processor 408 is coupled to memory bridge 406 via a bus or other communication path (e.g., a PCI Express, Accelerated Graphics Port, or HyperTransport link); in one embodiment display processor 408 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 404.

Display processor 408 periodically delivers pixels to a display device 410 (e.g., a screen or conventional CRT, plasma, OLED, SED or LCD based monitor or television). Display processor 408 can provide display device 410 with an analog or digital signal. In one embodiment, display processor 408 incorporates circuitry optimized for general purpose processing. In another embodiment, display processor 408 may be integrated with one or more other system elements, such as the memory bridge 406, CPU 402, and I/O bridge 411 to form a system on chip (SoC). In still further embodiments, display processor 408 is omitted and software executed by CPU 402 performs the functions of display processor 408.

A system disk 412 is also connected to I/O bridge 411 and may be configured to store content and applications and data for use by CPU 402 and display processor 408. System disk 412 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 414 provides connections between I/O bridge 411 and other components such as a network adapter 420 and various add-in cards 416 and 418. Network adapter 420 allows system 400 to communicate with other systems via an electronic communications network, and may include wired or wireless communication over local area networks and wide area networks such as the Internet.

Other components (not shown), including USB or other port connections, film recording devices, and the like, may also be connected to I/O bridge 411. For example, an audio processor may be used to generate analog or digital audio output from instructions and/or data provided by CPU 402, system memory 404, or system disk 412. Communication paths interconnecting the various components in FIG. 10 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

The system 400 can be configured to perform the embodiments of the methods described above, or portions thereof. In one embodiment, the system 400 can comprise at least a CPU 402, system memory 404 and input devices 422. The system memory 404 can contain instructions which, when performed by the CPU 402, cause the system 400 to perform one or more of the steps described with reference to the methods above. The system 400 can receive information through the one or more input devices 422. Input devices 422 can include user-controlled (e.g. keyboards, mouse, etc) and automatic (e.g. ECG electrodes, pulse oximeters, etc) input devices 422. The information received by the system 400 can be related to parameters, developmental goals, development regimens or other details pertinent to the states or performances described with reference to FIGS. 1, 2 and 3. The system 400 can be configured to determine the state or performance of a person or the expected state or performance for a job demand based on one or more parameters, input through the one or more input devices 422. The system 400 can be further configured to provide an development regimen, a physical therapy regimen or work regimen to the person. The regimens can be provided to the person using the display device 410, one on more printers (not shown), electronically delivered to another system, or by other means known in the art. The system 400 can be configured for continuous monitoring or periodic monitoring of developmental goals, performance of one or more job demands or injury events, described with reference to FIGS. 1, 2 and 3. Monitoring can be performed by the system 400 through user-controlled or automatic input devices 422. Input received through the one or more input devices 422 can be stored locally using system memory 404.

It will be appreciated that the system shown herein is illustrative and that variations and modifications are possible. The connection topology, including the number and arrangement of bridges, may be modified as desired. For instance, in some embodiments, system memory 404 is connected to CPU 402 directly rather than through a bridge, and other devices communicate with system memory 404 via memory bridge 406 and CPU 402. In other alternative topologies display processor 408 is connected to I/O bridge 411 or directly to CPU 402, rather than to memory bridge 406. In still other embodiments, I/O bridge 411 and memory bridge 406 might be integrated into a single chip. The particular components shown herein are optional; for instance, any number of add-in cards or peripheral devices might be supported. In some embodiments, switch 414 is eliminated, and network adapter 420 and add-in cards 416, 418 connect directly to I/O bridge 411.

Network computers are another type of computer system that can be used in conjunction with the teachings provided herein. Network computers do not usually include a hard disk or other mass storage, and the executable programs are loaded from a network connection into the memory 404 for execution by the CPU 402. A Web TV system, which is known in the art, is also considered to be a computer system, but it may lack some of the features shown in FIG. 4, such as certain input or output devices. A typical computer system will usually include at least a processor, memory, and a bus coupling the memory to the processor. In some embodiments, the system 400 may include one or more CPUs 402, one or more display processors 408, and/or one or more of any of the system elements included in FIG. 4.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The components presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description above. In addition, the present examples are not described with reference to any particular programming language, and various examples may thus be implemented using a variety of programming languages.

While the forgoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

FIG. 5 is a depiction of a program capable of performing one or more embodiments described herein. In this embodiment an input screen 500 is depicted. The input screen 500 can have one or more tests which can be performed in one or more embodiments. The tests can include one or more hand strength tests, one or more pinch strength test, one or more muscle strength tests, one or more static lift tests, one or more dynamic lift tests and one or more algometry tests (a measurement for pain). The hand strength test can be subdivided into subcategories, such as rapid exchange, maximum voluntary effort (MVE) or others as needed. Pinch strength can be subdivided into subcategories such as key, tip palmar and grasp. Muscle test can be subdivided into cervical, elbow, knee, hip, shoulder waist and ankle, each of which can include further subcategories as needed. Static lift and dynamic lift can be subdivided into various height ranges and directionalities or others as needed by the user. The user can select through the categories and subcategories to choose which parameters are needed for the evaluation based on the job demands.

In another embodiment, an input screen can depict information received from one or more tests as described below, which can be performed in one or more embodiments. The tests can include one or more total spine or extremity range of motion tests. The tests can include one or more of the preselected tests including but not limited to lumbar, thorasic, cervical spine measures or any joint on the body including elbow, wrist, shoulder, knee and so forth. Dual inclinometry can segment out the portion of the spine being tested. The dual inclinometry can be performed in accordance with standards known in the industry, such as the American Medical Association Guidelines to permanent Impairment criteria. A goniometer can further be incorporated into one or more embodiments. The goniometer can provide one or more measures which are used for the extremities.

In another embodiment, an input screen can depict information received from one or more tests as described below, which can be performed in one or more embodiments. The tests can include one or more occupational tasks. Occupational tasks are defined as tasks performed during the performance of a job or occupation. The tests can include more than one selection at a time. Each selection can be adjusted based on distance, weight, frequency of the related job task or combinations thereof. Each test can be based upon industrial standards and methods, time measurements, analysis criteria or combinations thereof. The analysis of the tests allows the clinician to accurately access and extrapolate various occupation important criteria, such as an individual's ability to withstand the task over an average eight hour work day with average breaks. This series of tests can include parameters such as extended and reaching, kneeling and squatting, fine finger dexterity and handling, stair/ladder climbing and others The parameters can be considered essential duties of job performance.

In another embodiment, an input screen can depict information received from one or more tests as described below, which can be performed in one or more embodiments, The tests can include one or more subjective client response charts. The standardized pain illustration and activity overview allow the clinician the ability to analyze the existing client's perception of abilities and discomfort prior to testing activities.

The input received by the input screen can be used to provide calculations, norms crosschecks, various reports and data correlation among other permutations of data analysis. The program or the practitioner can then analyze the output to determine various parameters as described above, such as the job demands, the expected state or performance of the person, or post-offer pre-employment screening.

In further embodiments, the program can accept input based on observation coupling, strength testing, cardiovascular detection, occupational tasks, simulated activities and others. The program can then process the input received to produce one or more output. Thus, the program can, either through manual input or through collected data from the one or more user input devices 422, perform one or more of the tasks described above with reference to FIGS. 1, 2 and 3. Further, the program can educate the practitioner regarding recent changes or health considerations, based on the data collected and the job demands.

The program can include a job demands analysis/evaluation which can cover the essential and critical demands of the job including a review of the critical cadence in the environment. The job demands analysis can include weight loads, distances, repetition of tasks, sustained postures, range of movement and other details. The program can further include post offer pre-employment screening thus providing an evaluation and report that determines the physical abilities of an individual in comparison to work requirements and reports a pass or fail indicator for employers who are in the hiring process. The program can further include progress checks throughout job-specific rehabilitation providing strength and range of motion measures that are used as baselines and benchmarks throughout rehab to determine the effectiveness of treatment and subsequently to determine whether or not the patient or employee has reached maximal medical improvement (MMI). The program can further include a functional capacity or requirement evaluations which can constitute a full measure of the strength, range of motion, cardiovascular abilities as well as occupational tasks of an individual in comparison to either the field of work or to a specific job. The program can further include job transfer tests which can be used as an evaluation tool to determine if an individual from a less demanding job or an individual who is post injury has the physical ability to perform at a higher physically demanding job in a safe and sustained manner. The program can further include preventative maintenance testing regarding workforce aging such as periodic evaluations to determine loss in range of motion or strength of employees in high risk work activities. The program can further include assistance in the measurement of and documenting ergonomic hazards which can be used to perform work related measurements for tasks such as push and pull tolerances in the workplace environment.

The above are standard embodiments of the program and are not intended to be limiting of possible embodiments.

### CONCLUSION

Embodiments described herein relate to methods of treating and preventing injury, such as overexertion injury. Job related injury is both common and expensive to the employee and the employer. Embodiments described herein disclose methods of preparing a person for one or more job demands, assisting in the recovery from an injury with minimal downtime and prevention of job related injury. By treating, conditioning and monitoring the health and wellbeing of the person at each step of the work cycle, injury can largely be prevented and productivity can be increased.

While the foregoing is directed to embodiments of the present invention, other and further embodiments of the invention may be devised without departing from the basic scope thereof, and the scope thereof is determined by the claims that follow.

What is claimed is:

1. A method of monitoring and conditioning a person, comprising:
performing an analysis of a job to determine one or more job demands;
determining an expected state of a person based on the one or more job demands;
performing a screen to determine a baseline state of the person;
comparing the baseline state of the person to the expected state, the comparison comprising one or more developmental goals;
providing an development regimen to the person, wherein the development regimen targets the one or more developmental goals for achieving the expected state;
performing one or more functional requirement evaluations during and after performance of the development regimen to assess progress with relation to the one or more developmental goals;
adjusting the development regimen in response to the one or more second functional requirement evaluations until the expected state is reached;
tasking the person to perform the one or more job demands which corresponds with the expected state;
monitoring the person during performance of the one or more job demands for an injury event or a pre-injury event; and
if an injury event or pre-injury event occurs, providing a job-specific rehabilitation to achieve a rehabilitated state, wherein the job-specific rehabilitation is function oriented.

2. The method of claim 1, wherein the development regimen is modified based on the baseline state of the person associated with a second job demand.

3. The method of claim 1, further comprising reviewing historical injury and illness data related to a job to determine one or more high risk activities.

4. The method of claim 3, wherein the one or more duties includes carrying a weight over a distance, repeating a desired tasks, sustaining a posture for a period of time, moving within a desired range of movement or combinations thereof.

5. The method of claim 1, wherein the development regimen is adjusted based on an expected level of improvement.

6. The method of claim 1, the baseline state of the person is determined before employment begins.

7. The method of claim 1, further comprising providing a modified job demand such that the performance of the modified job demand works in conjunction with the physical therapy to help the person achieve the expected state or the rehabilitated state.

8. A method for providing job-specific rehabilitation, comprising:
performing an analysis of a job to determine one or more job demands;
determining a rehabilitated performance of the person based on the one or more job demands;
performing a screen to assess a beginning performance of a person;
providing a rehabilitation regimen to the person which accommodates for the difference between the beginning performance or a current performance and the rehabilitated performance as associated with the one or more job demands, wherein the rehabilitation regimen comprises modified work, transitional work, job rotation, physical therapy, fitness programs or combinations thereof;
performing a functional requirement evaluation to assess the current performance of the person after receiving the rehabilitation regimen over a period of time, wherein the rehabilitation regimen helps the person achieve the rehabilitated performance;
updating the rehabilitation regimen to accommodate the difference between the current performance and the rehabilitated performance; and
repeating providing the rehabilitation regimen, performing the functional requirement evaluation and updating the rehabilitation regimen until the person has at least achieved the rehabilitated performance.

9. The method of claim 8, wherein assessing the beginning performance of the person occurs after an offer of employment is given but before employment begins.

10. The method of claim 8, wherein the person has a non-impact injury, the non-impact injury related to one or more job demands.

11. The method of claim 8, wherein the expected performance is a state of the person which allows the person to perform the one or more job demands effectively while reducing or removing the risk of a non-impact injury.

12. The method of claim 8, wherein the one or more job demands are assessed in connection with assessing either the beginning performance or the current performance of the person.

13. The method of claim 12, wherein the rehabilitated performance is updated when the one or more job demands are assessed.

14. The method of claim 8, wherein the one or more job demands are adjusted to match the rehabilitated performance, wherein the rehabilitated performance corresponds to maximal medical improvement.

15. A method of preventing injury in a person, comprising:
performing an analysis of a job to determine one or more job demands;
performing one or more screens to assess a healthy performance of a person over a period of time, wherein the healthy performance corresponds to the ability of the person to fulfill a job demand after reaching at least an expected performance but prior to injury;
periodically performing a functional requirement evaluation to assess a current performance of the person;
comparing the current performance to the healthy performance to determine a change in performance related to one or more job demands;
comparing change in performance to one or more known indicators of pre-injury to determine if a pre-injury state exists;
if a pre-injury state exists, providing a rehabilitation regimen to the person, wherein the rehabilitation regimen comprises modified work, transitional work, job rotation, physical therapy, fitness programs or combinations thereof; and
repeating periodically evaluating the current performance, comparing the current performance to the healthy performance and providing the rehabilitative regimen until the person achieves at least an expected performance.

16. The method of claim 15, wherein the rehabilitated performance corresponds to maximum medical improvement.

17. The method of claim 15, wherein the one or more rehabilitative activities are selected from the group comprising modified work, transitional work, job rotation, physical therapy, fitness programs or combinations thereof.

18. The method of claim 15, wherein the healthy performance is the performance of a person as determined in a post-offer pre-employment screen.

19. The method of claim 15, wherein the rehabilitation regimen further comprises one or more ergonomic changes.

20. The method of claim 15, wherein the one or more known indicators of pre-injury is a likelihood of injury based on time performing the one or more job demands as compared to one or more similarly-situated persons.
